(19) United States
(12) Patent Application Publication
(10) Pub. No.: US 2020/0198405 A1
(43) Pub. Date: Jun. 25, 2020

(54) WINTER TIRE TREAD

(71) Applicant: The Goodyear Tire & Rubber Company, Akron, OH (US)

(72) Inventors: Benjamin Philipot, Hettange Grande (FR); Jan Leyssens, Leglise-Beheme (BE); Robin Moia, Metz (FR); Roel Creton, Folschette (LU)

(21) Appl. No.: 16/227,129

(22) Filed: Dec. 20, 2018

(51) Int. Cl. B60C 11/03; B60C 11/12

(52) U.S. Cl. CPC B60C 11/0302; B60C 11/1236; B60C 11/1204; B60C 2011/1245; B60C 2011/1254; B60C 2011/0346; B60C 2011/0353; B60C 2011/0355; B60C 2011/1213; B60C 2011/0348

(57) ABSTRACT

A tread for a tire includes a center rib formed by two circumferential main grooves extending along a tire circumferential direction in a center of a tread width direction. Each circumferential main groove being the same axial distance from a tire equatorial plane of the tread. The center rib has a plurality of first main inclined grooves and a plurality of second main inclined grooves. The first and second main inclined grooves are inclined oppositely with respect to the tire circumferential direction such that the first and second main inclined grooves become distanced from the tire equatorial plane from trailing edges in a tire rotational direction toward leading edges. One zigzag shaped central groove is disposed on one side of the tire equatorial plane and the other zigzag shaped central groove is disposed on an opposite side of the tire equatorial plane.

### FIELD OF INVENTION

The present technology relates to a tire tread that improves stability on snow-covered road surfaces without causing a deterioration in steering stability on dry and wet road surfaces.

### BACKGROUND OF THE PRESENT INVENTION

Conventionally, the object of a tire is to reduce hydroplaning and improve winter performance without reducing dry performance. The tread of the conventional tire may be equipped with a center block column extending in the tire circumferential direction and block columns arranged in a shoulder portion and separated from the center block column by two circumferential grooves. The tread may thereby guide water from a center circumferential flat plane to both sides by providing grooved blocks of the center block column. The grooved blocks may be made up of two groove portions that are separated from each other by an inclined groove and intersect in the center circumferential flat plane by forming an angle with the inclined groove. Moreover, the tread may discharge snow by providing circumferential grooves that extend at an acute angle with respect to the tire equatorial plane (tire circumferential flat plane).

The conventional tire may further include grooves connecting to the adjacent inclined grooves in the tire circumferential direction (tire rolling direction). These connecting groove may become narrower to equalize the size of the blocks of the center block column. Although making the grooves narrower may be effective with respect to snow-covered road surfaces, steering stability on dry road surfaces may be impacted since the stiffness of the blocks is also altered. Additionally, water discharge performance may be reduced and steering stability on wet road surfaces may be reduced since the grooves that connect with the inclined grooves are inclined in the direction opposite the inclined grooves and thus work against the action of the inclined grooves to guide water from the center circumferential flat plane to both sides and thus detrimentally return the water to the center circumferential flat plane side.

### Definitions

“Apex” means an elastomeric filler located radially above the bead core and between the plies and the turnup ply.

“Annular” means formed like a ring.

“Aspect ratio” means the ratio of a tire section height to its section width.

“Aspect ratio of a bead cross-section” means the ratio of a bead section height to its section width.

“Asymmetric tread” means a tread that has a tread pattern not symmetrical about the centerplane or equatorial plane EP of the tire.

“Axial” and “axially” refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High tensile steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360 degree rotation about another filament or strand.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Net contact area” means the total area of ground contacting elements between defined boundary edges divided by the gross area between the boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65° and 90° with respect to the equatorial plane of the tire.

“Radial ply tire” means a belted or circumferentially-restricted pneumatic tire in which at least one ply has cords which extend from bead to bead are laid at cord angles between 65° and 90° with respect to the equatorial plane of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane.

“Section width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### SUMMARY OF THE INVENTION

A first tread for a tire in accordance with the present invention includes a center rib formed by two circumferential main grooves extending along a tire circumferential direction in a center of a tread width direction. Each circumferential main groove being the same axial distance from a tire equatorial plane of the tread. The center rib has a plurality of first main inclined grooves and a plurality of second main inclined grooves. The first and second main inclined grooves are inclined oppositely with respect to the tire circumferential direction such that the first and second main inclined grooves become distanced from the tire equatorial plane from trailing edges in a tire rotational direction toward leading edges. The trailing edges of the first main inclined grooves connect with one circumferential main groove. The trailing edges of the second main inclined grooves connect with the other circumferential main groove. The first and second main inclined grooves are arranged such that mutual leading edges thereof are disposed alternately in the tire circumferential direction, extend axially beyond the tire equatorial plane, and define two zigzag shaped central grooves along the tire circumferential direction. One zigzag shaped central groove is disposed on one side of the tire equatorial plane and the other zigzag shaped central groove is disposed on an opposite side of the tire equatorial plane.

According to another aspect of the first tread, each first main inclined groove intersects with between 3 and 6 second main inclined grooves with leading edges of each first main inclined groove being disposed at a different second main inclined groove.

According to still another aspect of the first tread, each second main inclined groove intersects with between 3 and 6 first main inclined grooves with leading edges of each second main inclined groove being disposed at a different first main inclined groove.

According to yet another aspect of the first tread, each zigzag groove has a groove width in a range from 2.0 mm to 6.0 mm.

According to still another aspect of the first tread, the first and second main inclined grooves radially outside of the zigzag grooves have a groove width in a range of 2.0 mm to 10.0 mm and a radial groove depth in a range of 2.0 mm to 10.0 mm.

According to yet another aspect of the first tread, the first and second main inclined grooves have a curved shape.

According to still another aspect of the first tread, the first and second main inclined grooves form opposite angles with respect to the circumferential main grooves, the angles being between 56° and 76° and −56° and −76°.

According to yet another aspect of the first tread, the first and second main inclined grooves form equal and opposite angles with respect to the circumferential main grooves at trailing edges connecting to the circumferential main grooves.

According to still another aspect of the first tread, a first shoulder rib and a second shoulder are disposed adjacent the center rib. The first and second shoulder ribs includes inclined transverse grooves extending axially outward from the circumferential main grooves.

According to yet another aspect of the first tread, the inclined transverse grooves have a groove width from 2.0 mm to 4.0 mm and a radial groove depth from 2.0 mm to 4.0 mm.

A second tread for a tire in accordance with the present invention includes a center rib formed by two circumferential main grooves extending along a tire circumferential direction in a center of a tread width direction. Each circumferential main groove is the same axial distance from a tire equatorial plane of the second tread. The center rib has a plurality of first main inclined grooves and a plurality of second main inclined grooves. The first and second main inclined grooves are inclined oppositely with respect to the tire circumferential direction such that the main inclined grooves become distanced from the tire equatorial plane from trailing edges in a tire rotational direction toward leading edges. The trailing edges of the first main inclined grooves connect with one circumferential main groove. The trailing edges of the second main inclined grooves connect with the other circumferential main groove. The first and second main inclined grooves are arranged such that mutual leading edges thereof are disposed alternately in the tire circumferential direction, extend axially beyond the tire equatorial plane, and define a zigzag shaped central groove extending along the tire circumferential direction. The zigzag shaped central groove is completely disposed on one side of the tire equatorial plane.

According to another aspect of the second tread, each first main inclined groove intersects with 4 second main inclined grooves with leading edges of each first main inclined groove being disposed at a different second main inclined groove.

According to still another aspect of the second tread, each second main inclined groove intersects with 5 first main inclined grooves with leading edges of each second main inclined groove being disposed at a different first main inclined groove.

According to yet another aspect of the second tread, each zigzag groove has a groove width in a range from 2.0 mm to 6.0 mm.

According to still another aspect of the second tread, the main inclined grooves radially outside of the zigzag groove have a groove width in a range of 2.0 mm to 10.0 mm and a radial groove depth in a range of 2.0 mm to 10.0 mm.

According to yet another aspect of the second tread, the first and second main inclined grooves have a linear shape.

According to still another aspect of the second tread, the first and second main inclined grooves form opposite angles with respect to the circumferential main grooves, the angles being between 50° and 70° and −50° and −70°.

According to yet another aspect of the second tread, a shoulder rib is disposed adjacent the center rib. The shoulder rib includes inclined transverse grooves extending axially outward.

According to still another aspect of the second tread, the inclined transverse grooves have a groove width from 2.0 mm to 4.0 mm and a radial groove depth from 2.0 mm to 4.0 mm.

According to yet another aspect of the second tread, a second shoulder rib is disposed adjacent the center rib on an opposite axial side of the center rib from the first shoulder rib. The second shoulder rib includes inclined transverse grooves extending axially outward at an angle opposite the inclined transverse grooves of the first shoulder rib.

### BRIEF DESCRIPTION OF THE DRAWINGS

The present invention will be more clearly understood by the following description of some examples thereof, with reference to the accompanying drawings, in which:

FIG. 1 is a schematic perspective view of an example tire in accordance with the present invention.

FIG. 2 is a schematic plan view of the tire illustrated in FIG. 1.

FIG. 3 is a schematic enlarged plan view of the tire illustrated in FIG. 1.

FIG. 4 is a schematic sectional view taken along line “4-4” in FIG. 3.

### DESCRIPTION OF EXAMPLES OF THE PRESENT INVENTION

An example of the present invention is described below in detail based on the drawings. However, the present invention is not limited to this example. The constituents of the example include components that may be replaced by those skilled in the art with components substantially equivalent. Furthermore, the multiple modified alternatives described in the example may be combined as desired within the scope apparent to one skilled in the art.

In the following description, “tire radial direction” refers to a direction orthogonal to the rotational axis of a tire 1; “inner side in the tire radial direction” refers to the side facing the rotational axis in the tire radial direction; and “outer side in the tire radial direction” refers to the side distanced from the rotational axis in the tire radial direction. The tire 1 may be pneumatic or non-pneumatic. Additionally, “tire width direction” refers to the direction parallel to the rotational axis; “inner side in the tire width direction” refers to the side facing a tire equatorial plane (tire equator line) CL in the tire width direction; and “outer side in the tire width direction” refers to the side distanced from the tire equatorial plane CL in the tire width direction. Furthermore, “tire circumferential direction” refers to a circumferential direction with the rotational axis as a center axis. “Tire equatorial plane CL” refers to a plane that is orthogonal to the rotational axis of the tire 1 and that passes through a center of a tire width of the tire 1. “Tire equator line” refers to a line along the circumferential direction of the tire 1 that lies on the tire equatorial plane CL. In this example, “tire equator line” is given the same reference symbol “CL” as that used for the tire equatorial plane.

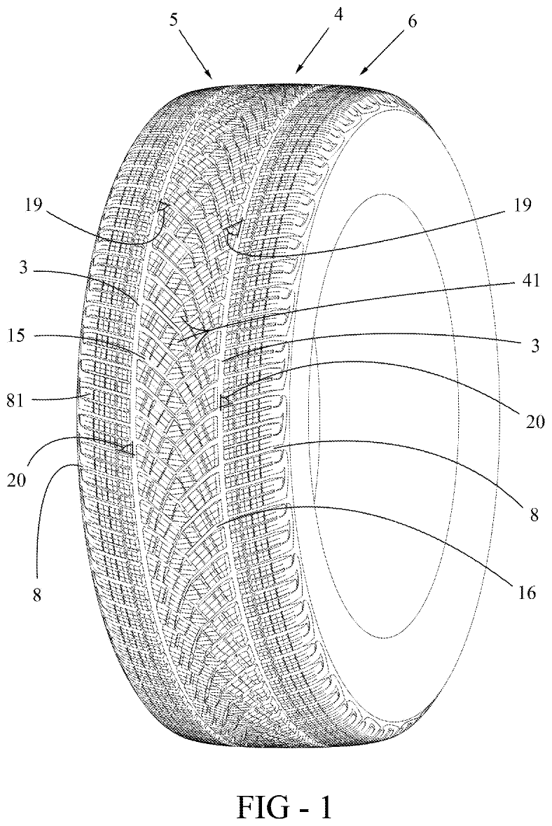

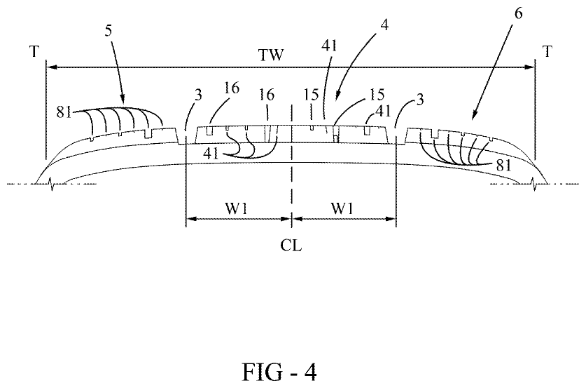

As illustrated in FIG. 1, an example tire 1 in accordance with the present invention may have a tread 2, or tread portion. The tread portion 2 may be formed from a rubber material exposed on a radially outermost side in the tire radial direction of the tire 1 thereby defining a profile of the tire 1 (FIG. 4). The tread portion 2 may have ground contact edges T set at certain positions on both axially outer sides in the tire width direction and a distance between the ground contact edges T in the tire width direction may be set as the ground contact width, or tread width TW.

The tread width TW may refer to the maximum width in the tire width direction of a region (e.g., a “ground contact region”) in which the tread portion 2 of the tire 1 contacts the road surface when the tire 1 is installed and loaded. The ground contact edges T may continue in the tire circumferential direction around the tire 1, as illustrated in FIGS. 1 & 2.

Two circumferential main grooves 3 may extend along the tire circumferential direction to both sides of the tire equatorial plane CL. Ribs that are parallel to the tire equatorial plane CL may and extend along the tire circumferential direction are formed on the surface 2a of the tread portion 2 by the two circumferential main grooves 3. A center rib 4 may extend circumferentially to both side of the tire equatorial plane CL and first and second shoulder ribs 5, 6 may extend circumferentially on the axially outer sides of the circumferential main grooves 3.

The circumferential main grooves 3 may be disposed such that an axial distance W1 from the tire equatorial plane CL to the center of the circumferential main grooves 3 is constant. For example, the axial distance W1 may be the tread width TW divided by 2, or 40 percent to 60 percent of the tread width TW. The circumferential main grooves 3 may have an axial groove width in a range of 2 percent to 10 percent of the tread width TW and a radial groove depth in a range of 6.0 mm to 10.0 mm. As shown in FIG. 4, groove walls of the circumferential main grooves 3 may be oriented in a relatively upright, or radial, position.

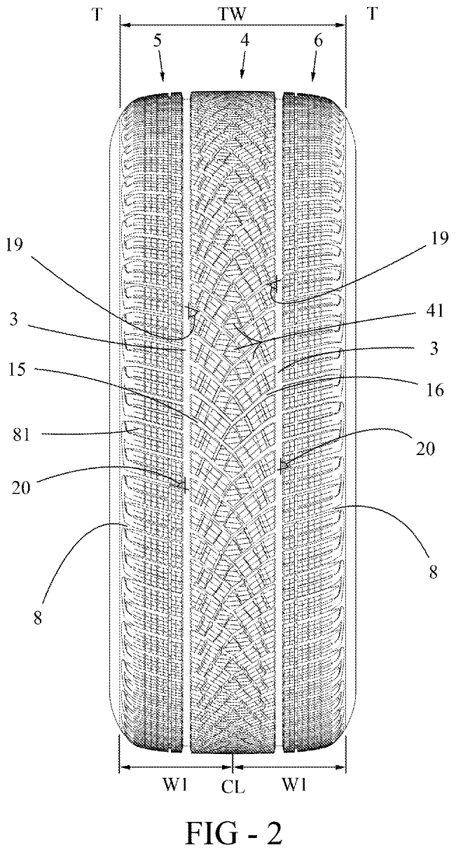

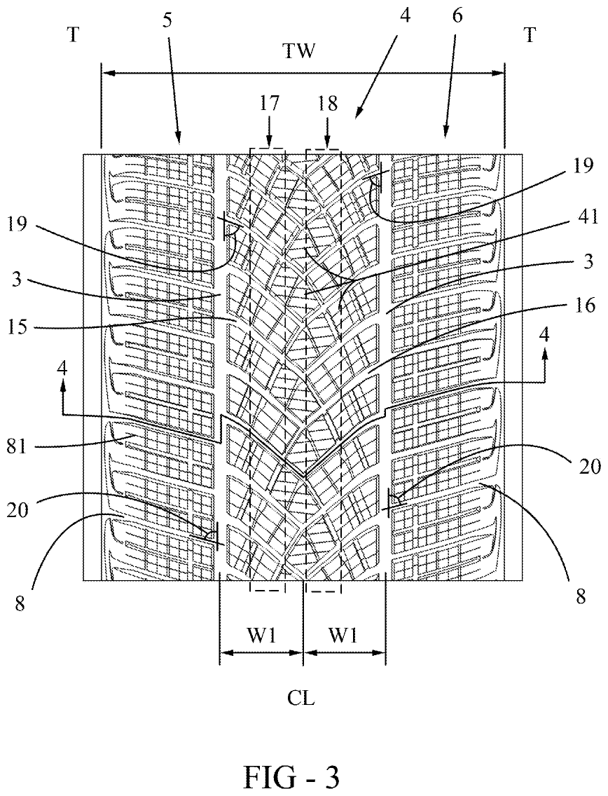

In accordance with the present invention, a plurality of first main inclined grooves 15 and a plurality of second main inclined grooves 16 may be in the center rib 4 of the tread 1. The first and second main inclined grooves 15, 16 may be inclined oppositely with respect to the tire circumferential direction such that the main inclined grooves 15, 16 become distanced from the tire equatorial plane CL from trailing edge in the tire rotational direction (downward in FIGS. 1-3) toward leading edge. Trailing edges of the first main inclined grooves 15 may connect with one circumferential main groove 3, while trailing edges of the second main inclined grooves 16 may connect with the other circumferential main groove 3. Furthermore, the first and second main inclined grooves 15, 16 may be arranged such that mutual leading edges thereof are disposed alternately in the tire circumferential direction, extend axially beyond the tire equatorial plane CL, and define two zigzag shaped central grooves 17, 18 along the tire circumferential direction on both axial sides of the tire equatorial plane CL. As shown in FIG. 3, the zigzag grooves 17, 18 may not be equidistant from, or symmetric about, the centerline CL of the tread 100.

Each first main inclined groove 15 may thereby cross over, or intersect, with 3, 4, 5, or 6 second main inclined grooves 16 with leading edges of each first main inclined groove 15 being disposed at a different second main inclined groove 16. Likewise, each second main inclined groove 16 may thereby cross over, or intersect, with 3, 4, 5, or 6 first main inclined grooves 15 with leading edges of each second main inclined groove 16 being disposed at a different first main inclined groove 15 (FIG. 3).

The zigzag grooves 17, 18 may be formed with a groove width in a range from 2.0 mm to 6.0 mm. The zigzag grooves 17, 18 may be formed with a radial groove depth in a range from 2.0 mm to 6.0 mm. The first and second main inclined grooves 15, 16 radially outside of the zigzag grooves 17, 18 may be formed with a groove width in a range of 2.0 mm to 10.0 mm and a radial groove depth in a range of 2.0 mm to 10.0 mm. The main inclined grooves 15, 16 may have a curved shape (FIGS. 1-3) or may also have a linear shape (not shown). The first and second main inclined grooves 15, 16 may form equal and opposite angles 19 with respect to the circumferential main grooves 3 (tire circumferential direction) at trailing edges connecting to the circumferential main grooves in a range of 56° to 76° and −56° to −76°; or 60° to 70° and −60° to −70°.

The first and second shoulder ribs 5, 6 may include inclined transverse grooves 8 extending generally axially outward from the circumferential main grooves 3. The inclined transverse grooves 8 may have a groove width from 2.0 mm to 4.0 mm, and a radial groove depth from 2.0 mm to 4.0 mm. The inclined transverse grooves 8 may form equal and opposite angles 19 with respect to the circumferential main grooves 3 (tire circumferential direction) at leading edges connecting to the circumferential main grooves in a range of 75° to 90° and −75° to −90°; or 80° to 90° and −80° to −90°.

The center rib 4 may also have a multitude of sipes 41 which may be linear, wavy, zigzag, curved, bent, and/or other suitable configuration. The sipes 41 may extend along the same directions as the first and second main inclined grooves 15, 16. The first and second shoulder ribs 5, 6 may have a multitude of sipes 81 which may be linear, wavy, zigzag, curved, bent, and/or other suitable configuration. The sipes 81 may extend along the same directions as the inclined transverse grooves 8.

The sipes 41, 81 may include configurations in which both ends are terminated (e.g., blind), a configuration in which one end is terminated and the other end communicates with a groove/sipe (e.g., one end blind), and a configuration in which both ends communicate with grooves/sipes.

In accordance with the present invention, the tread 2 of the example tire 1 may exhibit enhanced water discharge performance and enhanced snow discharge performance such that steering stability on wet road surfaces is increased and steering stability on snow-covered road surfaces is also increased by functioning of the first and second main inclined grooves 15, 16 extending from the center of the tire width direction (at or near the tire equatorial plane CL) toward the outer sides of the tread width TW. Moreover, through the intersections, at multiple locations with multiple grooves, of the first and second main inclined grooves 15, 16, overall stiffness of the tread 2 may be maintained such that steering stability on dry road surfaces may be acceptable or better. As a result, steering stability on snow-covered road surfaces may be improved without causing deterioration in steering stability on dry and wet road surfaces. Additionally, the zigzag shaped central grooves 17, 18 further contribute to this stability.

While certain representative details and examples have been shown for the purpose of illustrating the present invention, it will be apparent to those skilled in the art that various changes and/or modifications may be made therein without departing from the spirit or scope of the present invention as set forth by the following claims.

What is claimed:

1. A tread for a tire comprising:
a center rib formed by two circumferential main grooves extending along a tire circumferential direction in a center of a tread width direction, each circumferential main groove being the same axial distance from a tire equatorial plane of the tread;
the center rib having a plurality of first main inclined grooves and a plurality of second main inclined grooves, the first and second main inclined grooves being inclined oppositely with respect to the tire circumferential direction such that the main inclined grooves become distanced from the tire equatorial plane from trailing edges in a tire rotational direction toward leading edges,
the trailing edges of the first main inclined grooves connecting with one circumferential main groove, while the trailing edges of the second main inclined grooves connect with the other circumferential main groove,
the first and second main inclined grooves being arranged such that mutual leading edges thereof are disposed alternately in the tire circumferential direction, extend axially beyond the tire equatorial plane, and define two zigzag shaped central grooves along the tire circumferential direction, one zigzag shaped central groove disposed on one side of the tire equatorial plane and the other zigzag shaped central groove disposed on an opposite side of the tire equatorial plane.

2. The tread as set forth in claim 1 wherein each first main inclined groove intersects with between 3 and 6 second main inclined grooves with leading edges of each first main inclined groove being disposed at a different second main inclined groove.

3. The tread as set forth in claim 1 wherein each second main inclined groove intersects with between 3 and 6 first main inclined grooves with leading edges of each second main inclined groove being disposed at a different first main inclined groove.

4. The tread as set forth in claim 1 wherein each zigzag groove has a groove width in a range from 2.0 mm to 6.0 mm.

5. The tread as set forth in claim 1 wherein the first and second main inclined grooves radially outside of the zigzag grooves have a groove width in a range of 2.0 mm to 10.0 mm and a radial groove depth in a range of 2.0 mm to 10.0 mm.

6. The tread as set forth in claim 1 wherein the first and second main inclined grooves have a curved shape.

7. The tread as set forth in claim 1 wherein the first and second main inclined grooves form opposite angles with respect to the circumferential main grooves, the angles being between 56° and 76° and −56° and −76°.

8. The tread as set forth in claim 1 wherein the first and second main inclined grooves form equal and opposite angles with respect to the circumferential main grooves at trailing edges connecting to the circumferential main grooves.

9. The tread as set forth in claim 1 further including a first shoulder rib and a second shoulder disposed adjacent the center rib, the first and second shoulder ribs including inclined transverse grooves extending axially outward from the circumferential main grooves.

10. The tread as set forth in claim 9 wherein the inclined transverse grooves have a groove width from 2.0 mm to 4.0 mm and a radial groove depth from 2.0 mm to 4.0 mm.

11. A tread for a tire comprising:
a center rib formed by two circumferential main grooves extending along a tire circumferential direction in a center of a tread width direction, each circumferential main groove being the same axial distance from a tire equatorial plane of the tread;
the center rib having a plurality of first main inclined grooves and a plurality of second main inclined grooves, the first and second main inclined grooves being inclined oppositely with respect to the tire circumferential direction such that the main inclined grooves become distanced from the tire equatorial plane from trailing edges in a tire rotational direction toward leading edges,
the trailing edges of the first main inclined grooves connecting with one circumferential main groove, while the trailing edges of the second main inclined grooves connect with the other circumferential main groove,
the first and second main inclined grooves being arranged such that mutual leading edges thereof are disposed alternately in the tire circumferential direction, extend axially beyond the tire equatorial plane, and define a zigzag shaped central groove extending along the tire circumferential direction, the zigzag shaped central groove being completely disposed on one side of the tire equatorial plane.

12. The tread as set forth in claim 11 wherein each first main inclined groove intersects with 4 second main inclined grooves with leading edges of each first main inclined groove being disposed at a different second main inclined groove.

13. The tread as set forth in claim 11 wherein each second main inclined groove intersects with 5 first main inclined grooves with leading edges of each second main inclined groove being disposed at a different first main inclined groove.

14. The tread as set forth in claim 11 wherein each zigzag groove has a groove width in a range from 2.0 mm to 6.0 mm.

15. The tread as set forth in claim 11 wherein the main inclined grooves radially outside of the zigzag groove have a groove width in a range of 2.0 mm to 10.0 mm and a radial groove depth in a range of 2.0 mm to 10.0 mm.

16. The tread as set forth in claim 11 wherein the first and second main inclined grooves have a linear shape.

17. The tread as set forth in claim 11 wherein the first and second main inclined grooves form opposite angles with respect to the circumferential main grooves, the angles being between 50° and 70° and −50° and −70°.

18. The tread as set forth in claim 11 further including a shoulder rib disposed adjacent the center rib, the shoulder rib including inclined transverse grooves extending axially outward.

19. The tread as set forth in claim 18 wherein the inclined transverse grooves have a groove width from 2.0 mm to 4.0 mm and a radial groove depth from 2.0 mm to 4.0 mm.

20. The tread as set forth in claim 19 further including a second shoulder rib disposed adjacent the center rib on an opposite axial side of the center rib from the first shoulder rib, the second shoulder rib including inclined transverse grooves extending axially outward at an angle opposite the inclined transverse grooves of the first shoulder rib.
